(19) United States
(12) Patent Application Publication
(10) Pub. No.: US 2021/0281800 A1
(43) Pub. Date: Sep. 9, 2021

(54) METHODS AND APPARATUS FOR MAINTAINING CALL QUALITY BASED ON INACTIVITY

(71) Applicant: QUALCOMM Incorporated, San Diego, CA (US)

(72) Inventors: Shubhra SINGH, Bengaluru (IN); Sandeep PADUBIDRI RAMAMURTHY, Bangalore (IN); Shankar Ganesh LAKSHMANASWAMY, Bangalore (IN)

(21) Appl. No.: 16/810,713

(22) Filed: Mar. 5, 2020

(51) Int. Cl. H04N 7/14; H04L 29/06; H04L 12/26

(52) U.S. Cl. CPC H04N 7/147; H04N 7/148; H04L 65/1016; H04L 65/608; H04L 43/04; H04L 65/80

(57) ABSTRACT

The present disclosure relates to methods and devices for wireless communication including a UE and another UE or a base station. The UE can communicate via a current call communication with a current call quality, where the current call communication can be a RAT. The UE can also determine whether a current call activity is inactive for a time period. Additionally, the UE can maintain the current call quality when the current call activity is inactive for the time period. The UE can also monitor one or more data packets over the current call communication for the time period. Further, the UE can stop downgrading to a lower call quality when the current call activity is inactive for the time period. The UE can also switch the current call communication to a new call communication when the current call activity is inactive for the time period.

### BACKGROUND

### Technical Field

The present disclosure relates generally to communication systems, and more particularly, to call quality in wireless communication systems.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The apparatus may communicate via a current call communication with a current call quality, where the current call communication can be a radio access technology (RAT). The apparatus may also receive one or more data packets over the current call communication. Additionally, the apparatus may monitor one or more data packets over the current call communication for a time period. The apparatus may also determine whether a current call activity of the current call communication is inactive for a time period. Moreover, the apparatus may determine whether one or more data packets are not received over the current call communication for the time period. The apparatus may also maintain the current call quality when the current call activity is inactive for the time period. Further, the apparatus may stop downgrading the current call quality to a lower call quality when the current call activity is inactive for the time period. The apparatus may also switch the current call communication to a new call communication when the current call activity is inactive for the time period.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 is a diagram illustrating example communication between a UE and another UE or a base station in accordance with one or more techniques of the present disclosure.

FIG. 5 is a flowchart of a method of wireless communication in accordance with one or more techniques of the present disclosure.

FIG. 6 is a conceptual data flow diagram illustrating the data flow between different means/components in an example apparatus.

FIG. 7 is a diagram illustrating an example of a hardware implementation for an apparatus employing a processing system.

### DETAILED DESCRIPTION

In some aspects, data packet inactivity can signal that there is something wrong in a current communication network or RAT network, e.g., an LTE wireless network, a 5G wireless network, or a Wi-Fi network. For instance, video calls can transfer larger data packets, e.g., real-time transport protocol (RTP) packets or real-time transport control protocol (RTCP) packets, compared to voice calls. Also, these larger packets can be more difficult to transfer compared to other data packets, which can impact the call quality. In some instances, call operators or UEs may wait for different types of call inactivity, such as an RTP timeout and/or an RTCP timeout, in order to switch or downgrade the call. This inactivity may be due to an encoder or camera, e.g., a far end encoder or camera, not sending any frames or packets. Additionally, the call inactivity may be because of an issue with the network or downlink communication issues. However, switching or downgrading a call quality, e.g., downgrading from a video call quality to a voice call, can have a negative impact on the user experience. As such, there is a present need to detect any network issues early and avoid a downgrade of the video call to an audio call when there is a possibility of switching to another RAT and keeping the video call active. Aspects of the present disclosure can include methods and apparatus to avoid call status downgrades, e.g., from a video call status to voice call status, during a period of call inactivity, e.g., RTP packet or RTCP packet inactivity. As such, aspects of the present disclosure can detect any network issues early and avoid a downgrade of a video call to an audio call when there is a possibility of switching to another RAT and keeping the video call active.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

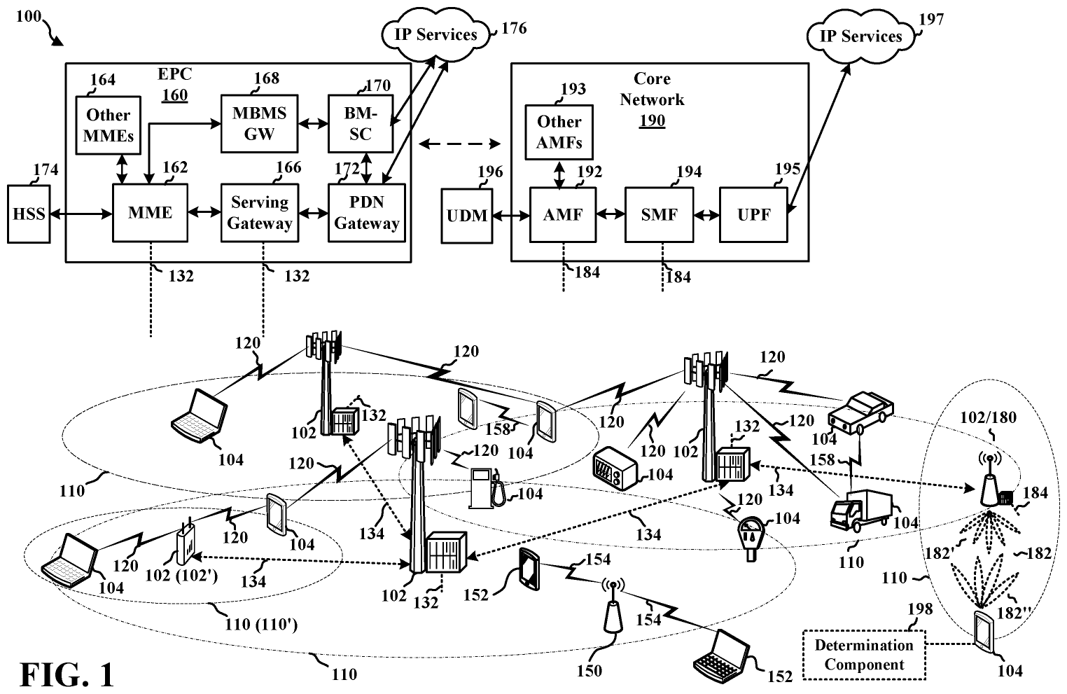

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a determination component 198 configured to communicate via a current call communication with a current call quality, where the current call communication can be a radio access technology (RAT). Determination component 198 may also be configured to receive one or more data packets over the current call communication. Determination component 198 may also be configured to monitor one or more data packets over the current call communication for a time period. Determination component 198 may also be configured to determine whether a current call activity of the current call communication is inactive for a time period. Determination component 198 may also be configured to determine whether one or more data packets are not received over the current call communication for the time period. Determination component 198 may also be configured to maintain the current call quality when the current call activity is inactive for the time period. Determination component 198 may also be configured to stop downgrading the current call quality to a lower call quality when the current call activity is inactive for the time period. Determination component 198 may also be configured to switch the current call communication to a new call communication when the current call activity is inactive for the time period.

Although the following description may be focused on 5G NR, the concepts described herein may be applicable to other similar areas, such as LTE, LTE-A, CDMA, GSM, and other wireless technologies.

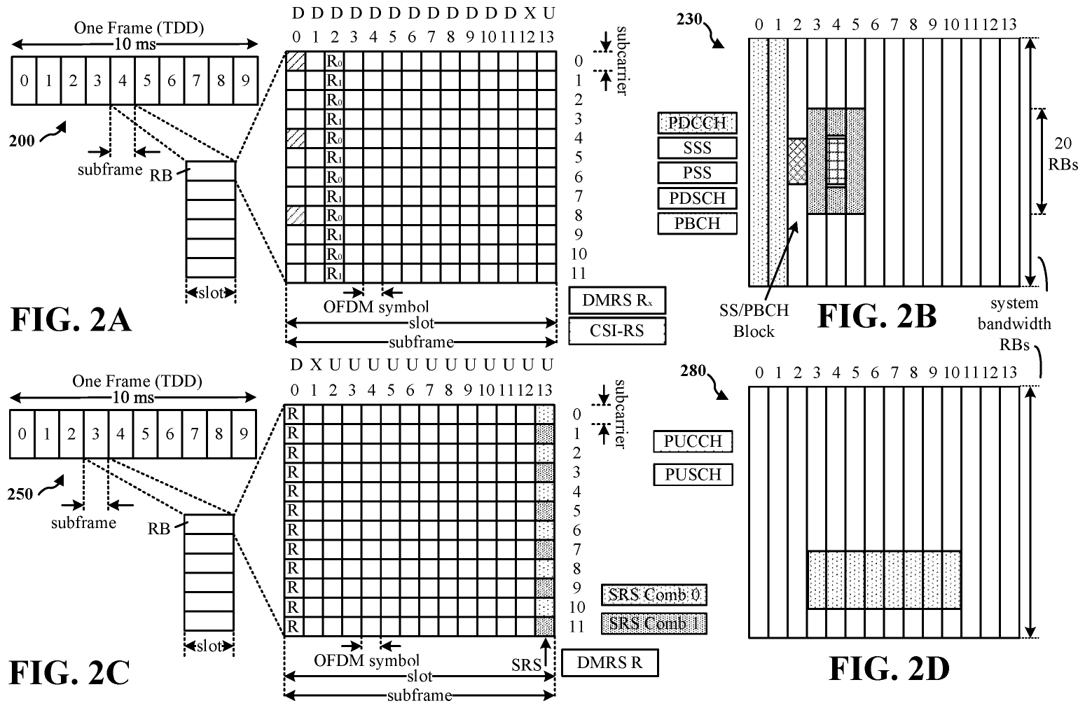

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

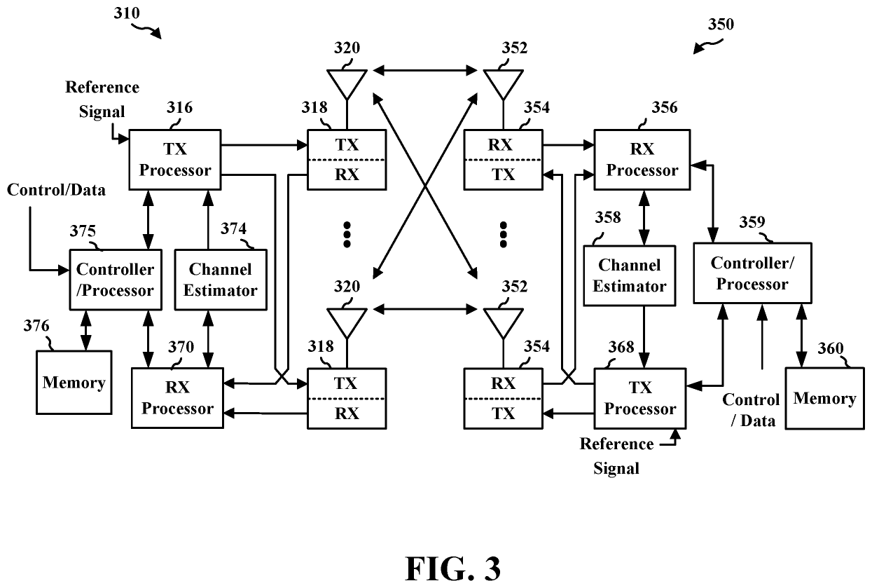

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Some aspects of wireless communication can include different types of calls, e.g., video calls or voice calls. In video calls or voice calls, information or data can be transferred in the form of packets, e.g., data packets. Also, the current communication network can be a radio access technology (RAT) network. The RAT network can be a number of different networks, such as an LTE wireless network, a 5G wireless network, or a Wi-Fi network.

In certain aspects of video calls, when data packets are not received for a certain time period, the type of call communication may be switched, such as by downgrading the call. For instance, when data packets, e.g., video real-time transport protocol (RTP) packets and/or real-time transport control protocol (RTCP) packets, are not received for a predefined interval, the call may be downgraded, e.g., to a voice call or an audio call. Accordingly, a call can be downgraded based on not receiving any data packets for a certain period of time, e.g., a time period of 20 or 25 seconds.

In some aspects, the aforementioned data packet inactivity can signal that there is something wrong in the current communication network or RAT network, e.g., an LTE wireless network, a 5G wireless network, or a Wi-Fi network. In some instances, different types of calls can transfer different types of data packets. For instance, video calls can transfer larger data packets, e.g., RTP or RTCP packets, compared to voice calls. Also, these larger packets can be more difficult to transfer compared to other data packets, which can impact the call quality.

In some instances, there can be multiple cases where data packets may not be transferred between UEs. As mentioned above, the data packets that are exchanged between different UEs can be RTP packets or RTCP packets. RTP is an application layer protocol, which can be used to send video data or data packets between different UEs. RTCP is a control protocol, where control packets that are exchanged between UEs can inform whether a call or communication line is active, as well as inform the UEs regarding other control data.

In some instances, call operators or UEs may wait for different types of call inactivity, such as an RTP timeout and/or an RTCP timeout, in order to switch or downgrade the call. This inactivity may be due to an encoder or camera, e.g., a far end encoder or camera, not sending any frames or packets. Additionally, the call inactivity may be because of an issue with the network or downlink communication issues.

In some aspects, e.g., when the call inactivity is based on an encoder or camera at a far end, changing the call communication type or RAT may not be helpful. For example, if a far end user or UE has gone to another application, e.g., a background and/or other phone application, there may be no need for the call to handoff to another type of communication or RAT. In some instances, during this inactivity time, the RTCP packets may be flowing properly.

In addition, switching or downgrading a call quality, e.g., downgrading from a video call quality to a voice call, can have a negative impact on the user experience. As such, there is a present need to detect any network issues early and avoid a downgrade of the video call to an audio call when there is a possibility of switching to another RAT and keeping the video call active. For instance, if there are data packet issues with the network, there may be an issue with the current RAT. In these instances, it may be beneficial to attempt to continue the video call over another RAT, rather than merely downgrading to a voice call.

Aspects of the present disclosure can include methods and apparatus to avoid call status downgrades, e.g., from a video call status to voice call status, during a period of call inactivity, e.g., RTP packet and/or RTCP packet inactivity. As such, aspects of the present disclosure can detect any network issues early and avoid a downgrade of a video call to an audio call when there is a possibility of switching to another RAT and keeping the video call active. For instance, aspects of the present disclosure can start an intermediate inactivity timer for video RTP packets and/or video RTCP packets for video calls. So the present disclosure can include a timer for a call, e.g., a timer for a certain period of time, where if no data packets are received for this certain amount of time, then the call will be transferred or handed off to another RAT. For example, the call can be handed off to LTE, NR, or Wi-Fi.

As indicated above, aspects of the present disclosure can continue a video call even if there are network connectivity issues, rather than downgrading the call to a voice call. So the present disclosure can hand off to a different RAT, rather than downgrading or switching a video call to a voice call. Thus, the present disclosure includes a motivation to continue a video call by handing off to another RAT, e.g., LTE, NR, or Wi-Fi, even when there are network inactivity issues, instead of downgrading a call quality. UEs according to the present disclosure can include the capability of utilizing multiple RATs, e.g., 5G, LTE, and/or Wi-Fi, for connection with another UE. By doing so, aspects of the present disclosure can switch or handoff to another RAT when there are data packet connection issues, rather than downgrading to a voice call.

Aspects of the present disclosure can also monitor the flow of RTP packets and/or RTCP packets between UEs and/or base stations. The present disclosure can monitor this flow of RTP and/or RTCP packets in order to determine whether there is a network connectivity issue. For example, aspects of the present disclosure can monitor or determine whether RTP packets are being received, but not RTCP packets, or vice versa. So the present disclosure can identify network issues based on the receipt or non-receipt of RTP packets and/or RTCP packets. As such, aspects of the present disclosure can identify, based on the receipt or non-receipt of data packets, whether there is a network issue, e.g., with a base station, or whether another UE is not sending data packets.

In some aspects, if a UE receives an RTCP report, this can signify that the UE is receiving certain data packets. For example, an RTCP report can identify that the UE is receiving RTCP packets, but not RTP packets, or vice versa. An RTCP report can be a report that includes changes to certain data packet counts, e.g., an octet count. So RTCP packets can include an octet count that can indicate the amount of RTP packets that are sent from another device, e.g., another UE or base station.

As indicated above, RTP packets are data packets that can include video information. RTCP packets are control packets that can include octet count data which can indicate the amount of data being transferred from one UE to another UE. In some instances, if there is a change to the octet count data, an RTCP packet can indicate that another UE or device is sending some amount of video data to the UE. Additionally, the RTCP packets can include metadata. In some aspects, a UE can receive RTCP reports or packets once every specified time period, e.g., every 1 or 5 seconds for video.

In some instances, a UE can conclude whether another UE or base station is sending data packets based on the RTCP reports. If the RTCP report indicates that the other UE is not sending data packets, then the UE can conclude that there is no network issue, so the UE can maintain a current call quality. If the RTCP report indicates that the other UE is sending data packets, but the UE is not receiving data packets, then the UE can switch from one RAT to another RAT. By doing so, this lack of data packet receipt can be resolved. This determination can be performed at a number of different layers of the UE, e.g., the internet protocol (IP) multimedia subsystems (IMS) layer.

In some aspects, if there are not any RTP packets being received, but RTCP packets are being received, and there is no increase in the sender octet count field of the RTCP packets, then the far end encoder or camera of a device may not be sending data packets. However, if there are not any RTP packets being received, but RTCP packets are being received, and there is an increase in sender octet count of the RTCP packets, then there may be some issue in the data packet flow. This can mean there is an issue with the network or base station in sending larger data packets, e.g., RTP packets. This can also indicate RAT issues, e.g., an issue with 5G NR, LTE, or Wi-Fi communication.

As indicated above, if data packets are not being received, this may be due to an encoder or camera not sending any frame or data packets. In these cases, the UE may not switch the RAT as this may not help solve the issue. So the UE may not switch to another RAT when the UE determines that another UE is not actually sending data packets. Additionally, the UE may switch to another RAT when another UE is sending data packets and the UE determines that there are network issues.

In some instances, if both RTP and RTCP packets are not received, there may have been a disruption in the network. For example, a power glitch, which can restart a Wi-Fi router, may have been disrupted. Additionally, UEs according to the present disclosure can determine that RTP packets are being sent by another UE or network, but these packets are not being received. In these instances, there can be an attempt to handoff or switch to another RAT for the VT call or video call, e.g., handoff from LTE to NR, LTE to Wi-Fi, NR to LTE, NR to Wi-Fi, Wi-Fi to NR, and/or Wi-Fi to LTE. Further, if the issues are not related to the RAT, e.g., there is a network or tower related issue, then the RAT can be switched so the UE can continue to receive RTP or RTCP packets.

In some aspects, if an RTP or RTCP inactivity timer indicates a certain amount of time, e.g., T seconds, aspects of the present disclosure may include an intermediate inactivity timer for a fraction of that time, e.g., T/2 seconds. As such, if over T/2 seconds there are no video RTP or RTCP packets received, aspects of the present disclosure may try to handoff to other RATs. Moreover, when the handoff is initiated, aspects of the present disclosure can check or test for the signal quality of the other available RATs, and then handoff once all the parameters are determined to be acceptable.

As indicated above, aspects of the present disclosure can avoid a video call downgrade to a voice call, e.g., when video RTP packets are not received for a predefined interval. In some instances, this can be based on an inactivity of receiving data packets and/or a low video call quality of the video packets being transferred. For instance, aspects of the present disclosure can continue a current call quality of a video call when there is an inactivity in receiving data packets by handing off to another available RAT.

In addition, in some aspects, irrespective of whether other types of data or audio packets are received, the present disclosure can start a handoff to another available RAT based on video RTP and RTCP packet inactivity. Accordingly, the video call may not be downgraded to a voice call, even if other types of data packets, e.g., audio packets, are not being received. By not downgrading the call, the present disclosure can help to maintain a high quality user experience. For instance, a user can continue to experience the high quality of a video call even when there is an issue with the data packets flow in a current RAT.

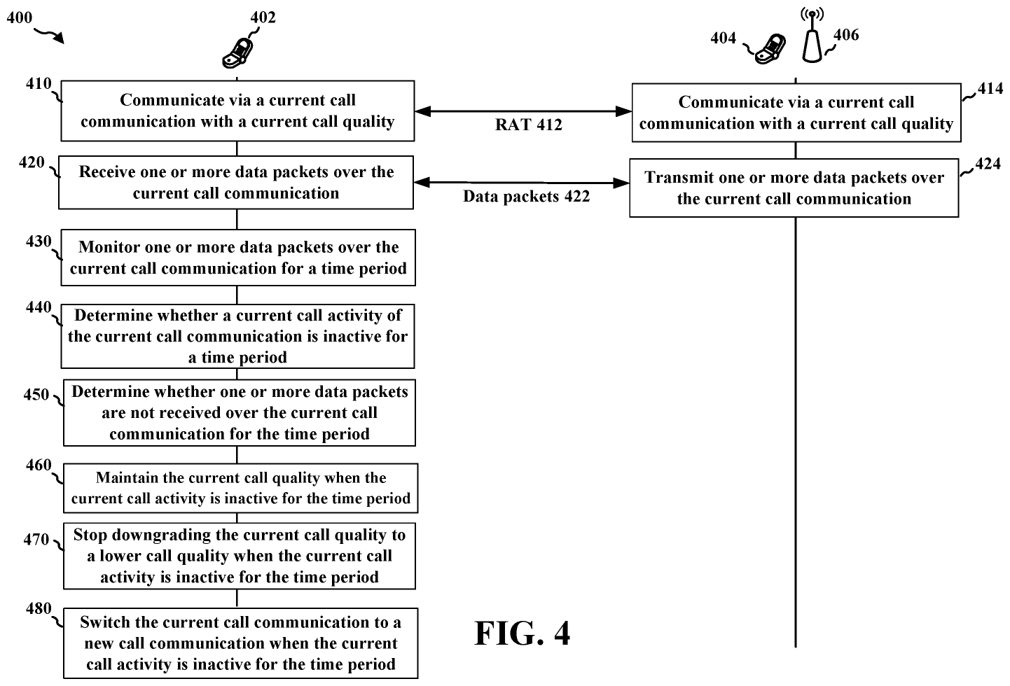

FIG. 4 is a diagram 400 illustrating example communication between a UE 402 and a UE 404 or base station 406. At 410, UE 402 may communicate via a current call communication, e.g., RAT 412, with a current call quality. In some instances, the current call communication can be a RAT, e.g., RAT 412. Additionally, the RAT, e.g., RAT 412, can include at least one of Long Term Evolution (LTE), New Radio (NR), or Wi-Fi.

At 414, UE 404 and/or base station 406 may communicate via a current call communication, e.g., RAT 412, with a current call quality. At 420, the UE 402 may receive one or more data packets, e.g., data packets 422, over the current call communication. At 424, UE 404 and/or base station 406 may transmit one or more data packets, e.g., data packets 422, over the current call communication.

At 430, UE 402 may monitor one or more data packets, e.g., data packets 422, over the current call communication for a time period. In some aspects, the one or more data packets may include at least one of one or more real-time transport protocol (RTP) packets or one or more real-time transport control protocol (RTCP) packets. Also, the one or more RTP packets can include video information data and the one or more RTCP packets include control data or octet count data.

At 440, UE 402 may also determine whether a current call activity of the current call communication, e.g., RAT 412, is inactive for a time period. Also, the current call activity can be inactive based on at least one of network quality issues or downlink communication issues. At 450, UE 402 may determine whether one or more data packets are not received over the current call communication, e.g., RAT 412, for the time period. In some aspects, the current call activity can be inactive when the one or more data packets are not received for the time period.

At 460, UE 402 may maintain the current call quality when the current call activity is inactive for the time period. At 470, UE 402 may stop downgrading the current call quality to a lower call quality when the current call activity is inactive for the time period. In some aspects, the lower call quality can be a voice call or an audio call. At 480, UE 402 may switch the current call communication, e.g., RAT 412, to a new call communication when the current call activity is inactive for the time period. In some aspects, the new call communication can be a RAT including at least one of Long Term Evolution (LTE), New Radio (NR), or Wi-Fi.

In some aspects, the determination whether the current call activity is inactive for the time period can be performed at an internet protocol (IP) multimedia subsystems (IMS) layer of the first UE, e.g., UE 402. Further, the current call quality can be a video telephony (VT) call or a video call. Additionally, the first UE can be communicating via the current call communication with at least one of a second UE, e.g., UE 404, and/or a base station, e.g., base station 406.

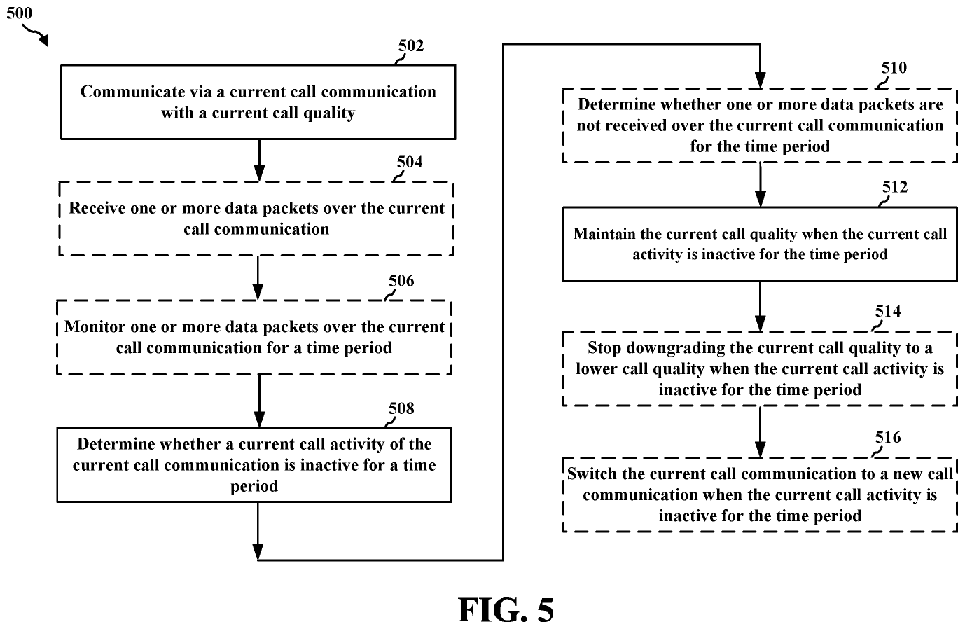

FIG. 5 is a flowchart 500 of a method of wireless communication. The method may be performed by a UE or a component of a UE (e.g., the UE 104, 350, 402, 404, 651; apparatus 602/602′; processing system 714, which may include the memory 360 and which may be the entire UE or a component of the UE, such as the TX processor 368, the RX processor 356, and/or the controller/processor 359). Optional aspects are illustrated with a dashed line. The methods described herein can provide a number of benefits, such as improving communication signaling, resource utilization, and/or power savings.

At 502, the UE may communicate via a current call communication with a current call quality, as described in connection with the example in FIG. 4. In some instances, the current call communication can be a RAT, as described in connection with the example in FIG. 4. Additionally, the RAT can include at least one of Long Term Evolution (LTE), New Radio (NR), or Wi-Fi, as described in connection with the example in FIG. 4. At 504, the UE may receive one or more data packets over the current call communication, as described in connection with the example in FIG. 4.

At 506, the UE may monitor one or more data packets over the current call communication for a time period, as described in connection with the example in FIG. 4. In some aspects, the one or more data packets may include at least one of one or more real-time transport protocol (RTP) packets or one or more real-time transport control protocol (RTCP) packets, as described in connection with the example in FIG. 4. Also, the one or more RTP packets can include video information data and the one or more RTCP packets include control data or octet count data, as described in connection with the example in FIG. 4.

At 508, the UE may determine whether a current call activity of the current call communication is inactive for a time period, as described in connection with the example in FIG. 4. Also, the current call activity can be inactive based on at least one of network quality issues or downlink communication issues, as described in connection with the example in FIG. 4. At 510, the UE may determine whether one or more data packets are not received over the current call communication for the time period, as described in connection with the example in FIG. 4. In some aspects, the current call activity can be inactive when the one or more data packets are not received for the time period, as described in connection with the example in FIG. 4.

At 512, the UE may maintain the current call quality when the current call activity is inactive for the time period, as described in connection with the example in FIG. 4. At 514, the UE may stop downgrading the current call quality to a lower call quality when the current call activity is inactive for the time period, as described in connection with the example in FIG. 4. In some aspects, the lower call quality can be a voice call or an audio call, as described in connection with the example in FIG. 4. At 516, the UE may switch the current call communication to a new call communication when the current call activity is inactive for the time period, as described in connection with the example in FIG. 4. In some aspects, the new call communication can be a RAT including at least one of Long Term Evolution (LTE), New Radio (NR), or Wi-Fi, as described in connection with the example in FIG. 4.

In some aspects, the determination whether the current call activity is inactive for the time period can be performed at an internet protocol (IP) multimedia subsystems (IMS) layer of the first UE, as described in connection with the example in FIG. 4. Further, the current call quality can be a video telephony (VT) call or a video call, as described in connection with the example in FIG. 4. Additionally, the first UE can be communicating via the current call communication with at least one of a second UE or a base station, as described in connection with the example in FIG. 4.

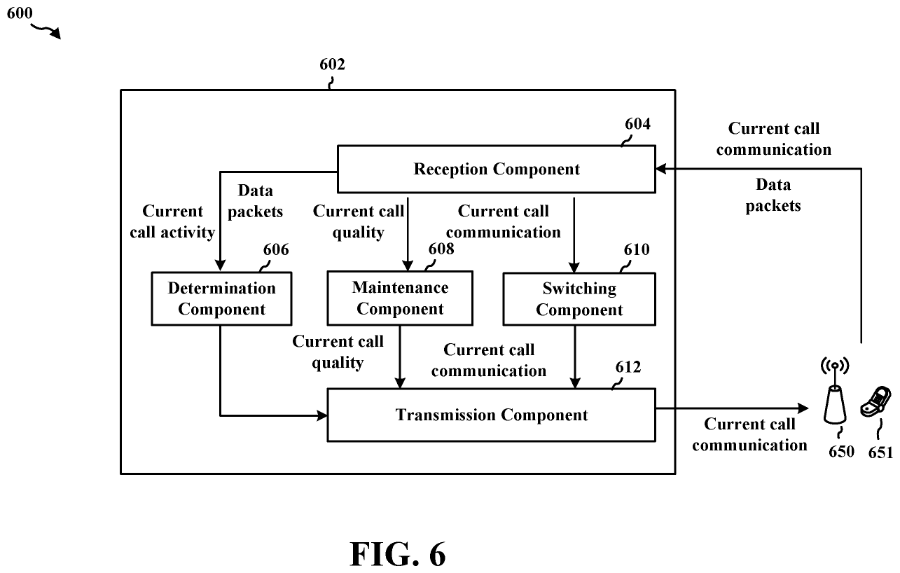

FIG. 6 is a conceptual data flow diagram 600 illustrating the data flow between different means/components in an example apparatus 602 with UE 651 and/or base station 650. The apparatus may be a UE. The apparatus includes a reception component 604 that may be configured to communicate via a current call communication with a current call quality, where the current call communication can be a radio access technology (RAT), e.g., as described in connection with step 502 in FIG. 5. Reception component 604 may also be configured to receive one or more data packets over the current call communication, e.g., as described in connection with step 504 in FIG. 5. The apparatus also includes a determination component 606 that may be configured to monitor one or more data packets over the current call communication for a time period, e.g., as described in connection with step 506 in FIG. 5. Determination component 606 may also be configured to determine whether a current call activity of the current call communication is inactive for a time period, e.g., as described in connection with step 508 in FIG. 5. Determination component 606 may also be configured to determine whether one or more data packets are not received over the current call communication for the time period, e.g., as described in connection with step 510 in FIG. 5. The apparatus also includes maintenance component 608 that may be configured to maintain the current call quality when the current call activity is inactive for the time period, e.g., as described in connection with step 512 in FIG. 5. Maintenance component 608 may also be configured to stop downgrading the current call quality to a lower call quality when the current call activity is inactive for the time period, e.g., as described in connection with step 514 in FIG. 5. The apparatus may also include switching component 610 that may be configured to switch the current call communication to a new call communication when the current call activity is inactive for the time period, e.g., as described in connection with step 516 in FIG. 5. The apparatus also includes a transmission component 612 that may be configured to communicate via a current call communication with a current call quality, e.g., as described in connection with step 502 in FIG. 5.

The apparatus may include additional components that perform each of the blocks of the algorithm in the aforementioned flowcharts of FIGS. 4 and 5. As such, each block in the aforementioned flowcharts of FIGS. 4 and 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

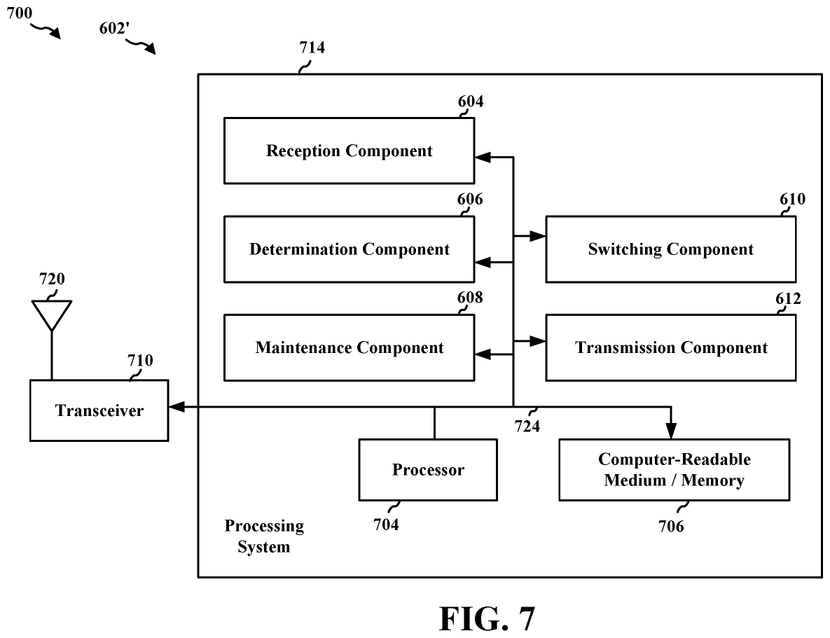

FIG. 7 is a diagram 700 illustrating an example of a hardware implementation for an apparatus 602′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware components, represented by the processor 704, the components 604, 606, 608, 610, 612, and the computer-readable medium/memory 706. The bus 724 may also link various other circuits such as timing sources, peripherals, voltage regulators, and power management circuits, which are well known in the art, and therefore, will not be described any further.

The processing system 714 may be coupled to a transceiver 710. The transceiver 710 is coupled to one or more antennas 720. The transceiver 710 provides a means for communicating with various other apparatus over a transmission medium. The transceiver 710 receives a signal from the one or more antennas 720, extracts information from the received signal, and provides the extracted information to the processing system 714, specifically the reception component 604. In addition, the transceiver 710 receives information from the processing system 714, specifically the transmission component 612, and based on the received information, generates a signal to be applied to the one or more antennas 720. The processing system 714 includes a processor 704 coupled to a computer-readable medium/memory 706. The processor 704 is responsible for general processing, including the execution of software stored on the computer-readable medium/memory 706. The software, when executed by the processor 704, causes the processing system 714 to perform the various functions described supra for any particular apparatus. The computer-readable medium/memory 706 may also be used for storing data that is manipulated by the processor 704 when executing software. The processing system 714 further includes at least one of the components 604, 606, 608, 610, 612. The components may be software components running in the processor 704, resident/stored in the computer readable medium/memory 706, one or more hardware components coupled to the processor 704, or some combination thereof. The processing system 714 may be a component of the UE 350 and may include the memory 360 and/or at least one of the TX processor 368, the RX processor 356, and the controller/processor 359. Alternatively, the processing system 714 may be the entire UE (e.g., see 350 of FIG. 3).

In one configuration, the apparatus 602/602′ for wireless communication may include means for communicating via a current call communication with a current call quality. The apparatus may also include means for determining whether a current call activity of the current call communication is inactive for a time period. The apparatus may also include means for maintaining the current call quality when the current call activity is inactive for the time period. The apparatus may also include means for monitoring one or more data packets over the current call communication for the time period. The apparatus may also include means for stopping downgrading the current call quality to a lower call quality when the current call activity is inactive for the time period. The apparatus may also include means for switching the current call communication to a new call communication when the current call activity is inactive for the time period. The apparatus may also include means for receiving one or more data packets over the current call communication. The apparatus may also include means for determining whether one or more data packets are not received over the current call communication for the time period.

The aforementioned means may be one or more of the aforementioned components of the apparatus 602 and/or the processing system 714 of the apparatus 602′ configured to perform the functions recited by the aforementioned means. As described supra, the processing system 714 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication of a first user equipment (UE), comprising:
communicating via a current call communication with a current call quality, wherein the current call communication is a radio access technology (RAT);
determining whether a current call activity of the current call communication is inactive for a time period;
maintaining the current call quality when the current call activity is inactive for the time period;
monitoring one or more data packets over the current call communication for the time period; and
responsive to determining that an intermediate inactivity timer has expired without receiving data packets, switching the current call communication to a new call communication.

2. (canceled)

3. The method of claim 1, wherein the one or more data packets include at least one of one or more real-time transport protocol (RTP) packets or one or more real-time transport control protocol (RTCP) packets.

4. The method of claim 3, wherein the one or more RTP packets include video information data and the one or more RTCP packets include control data or octet count data.

5. The method of claim 1, further comprising:
stopping downgrading the current call quality to a lower call quality when the current call activity is inactive for the time period.

6. The method of claim 5, wherein the lower call quality is a voice call or an audio call.

7. (canceled)

8. The method of claim 1, wherein the new call communication is a radio access technology (RAT) including at least one of Long Term Evolution (LTE), New Radio (NR), or Wi-Fi.

9. The method of claim 1, further comprising:
receiving one or more data packets over the current call communication.

10. The method of claim 1, further comprising:
determining whether one or more data packets are not received over the current call communication for the time period.

11. The method of claim 10, wherein the current call activity is inactive when the one or more data packets are not received for the time period.

12. The method of claim 1, wherein the current call activity is inactive based on at least one of network quality issues or downlink communication issues.

13. The method of claim 1, wherein the determination whether the current call activity is inactive for the time period is performed at an internet protocol (IP) multimedia subsystems (IMS) layer of the first UE.

14. The method of claim 1, wherein the current call quality is a video telephony (VT) call or a video call.

15. The method of claim 1, wherein the RAT includes at least one of Long Term Evolution (LTE), New Radio (NR), or Wi-Fi.

16. The method of claim 1, wherein the first UE is communicating via the current call communication with at least one of a second UE or a base station.

17. An apparatus for wireless communication of a first user equipment (UE), comprising:
a memory; and
at least one processor coupled to the memory and configured to:
communicate via a current call communication with a current call quality, wherein the current call communication is a radio access technology (RAT);
determine whether a current call activity of the current call communication is inactive for a time period;
maintain the current call quality when the current call activity is inactive for the time period;
monitor one or more data packets over the current call communication for the time period; and
responsive to determining that an intermediate inactivity timer has expired without receiving data packets, switch the current call communication to a new call communication when the current call activity is inactive for the time period.

18. (canceled)

19. The apparatus of claim 17, wherein the one or more data packets include at least one of one or more real-time transport protocol (RTP) packets or one or more real-time transport control protocol (RTCP) packets.

20. The apparatus of claim 19, wherein the one or more RTP packets include video information data and the one or more RTCP packets include control data or octet count data.

21. The apparatus of claim 17, wherein the at least one processor is further configured to:
stop downgrading the current call quality to a lower call quality when the current call activity is inactive for the time period, wherein the lower call quality is a voice call or an audio call.

22. The apparatus of claim 17, wherein the at least one processor is further configured to:
wherein the new call communication is a radio access technology (RAT) including at least one of Long Term Evolution (LTE), New Radio (NR), or Wi-Fi.

23. The apparatus of claim 17, wherein the at least one processor is further configured to:
receive one or more data packets over the current call communication.

24. The apparatus of claim 17, wherein the at least one processor is further configured to:
determine whether one or more data packets are not received over the current call communication for the time period, wherein the current call activity is inactive when the one or more data packets are not received for the time period.

25. The apparatus of claim 17, wherein the current call activity is inactive based on at least one of network quality issues or downlink communication issues.

26. The apparatus of claim 17, wherein the determination whether the current call activity is inactive for the time period is performed at an internet protocol (IP) multimedia subsystems (IMS) layer of the first UE.

27. The apparatus of claim 17, wherein the current call quality is a video telephony (VT) call or a video call, wherein the RAT includes at least one of Long Term Evolution (LTE), New Radio (NR), or Wi-Fi.

28. The apparatus of claim 17, wherein the first UE is communicating via the current call communication with at least one of a second UE or a base station.

29. An apparatus for wireless communication of a first user equipment (UE), comprising:
means for communicating via a current call communication with a current call quality, wherein the current call communication is a radio access technology (RAT);
means for determining whether a current call activity of the current call communication is inactive for a time period;
means for maintaining the current call quality when the current call activity is inactive for the time period;
means for monitoring one or more data packets over the current call communication for the time period; and
responsive to determining that an intermediate inactivity timer has expired without receiving data packets, means for switching the current call communication to a new call communication.

30. A non-transitory computer-readable medium storing computer executable code for wireless communication of a first user equipment (UE), the code when executed by a processor cause the processor to:
communicate via a current call communication with a current call quality, wherein the current call communication is a radio access technology (RAT);
determine whether a current call activity of the current call communication is inactive for a time period;
maintain the current call quality when the current call activity is inactive for the time period;
monitor one or more data packets over the current call communication for the time period;
and
responsive to determining that an intermediate inactivity timer has expired without receiving data packets, switch the current call communication to a new call communication when the current call activity is inactive for the time period.
